(19) United States
(12) Patent Application Publication
(10) Pub. No.: US 2025/0198462 A1
(43) Pub. Date: Jun. 19, 2025

(54) BEARING

(71) Applicant: AKTIEBOLAGET SKF, GOTEBORG (SE)

(72) Inventors: Wei LI, Shanghai (CN); Jianying YANG, Kunshan (CN); Wei WANG, Shanghai (CN); Hongyuan AN, Shanghai (CN)

(21) Appl. No.: 18/975,512

(22) Filed: Dec. 10, 2024

(30) Foreign Application Priority Data
Dec. 18, 2023 (CN) 202311744013.5

(51) Int. Cl. F16C 33/58; F16C 33/64; F16C 33/66; F16C 33/72

(52) U.S. Cl. CPC F16C 33/585; F16C 33/64; F16C 33/72; F16C 33/6688; F16C 2326/58

(57) ABSTRACT

A bearing includes an inner ring having an inner raceway, an outer ring having an outer raceway, rolling elements located between the inner raceway and the outer raceway and a cage for holding the rolling elements. A diameter Dr of the rolling elements satisfies Dr≤0.35*(H1−H2), where H1 is an outer diameter of the outer ring, and H2 is an inner diameter of the inner ring, and a relative groove curvature Ri of the inner raceway satisfies 0.52≤Ri≤0.58, and/or a relative groove curvature Re of the outer raceway satisfies 0.53≤Re≤0.58.

### CROSS-REFERENCE

This application claims priority to Chinese patent application no. 202311744013.5 filed on Dec. 18, 2023, the contents of which are fully incorporated herein by reference.

### TECHNOLOGICAL FIELD

The present disclosure is directed to a bearing, and more specifically, to a bearing with low friction torque.

### BACKGROUND

Some equipment that uses bearings requires bearings to have low friction torque when the bearings are running. For example, in a lithium battery film winding machine, if the friction torque of a bearing is large when the bearing is running, the film may have an uneven thickness or the film could even break. Therefore, it is often desirable to provide a bearing having a low friction torque when it is running.

### SUMMARY

According to a first aspect of the present disclosure, a bearing is that includes an inner ring having an inner raceway, an outer ring having an outer raceway, rolling elements located between the inner raceway and the outer raceway, and a cage for holding the rolling elements. A diameter Dr of the rolling elements satisfies Dr≤0.35*(H1−H2), where H1 is an outer diameter of the outer ring and H2 is an inner diameter of the inner ring. Furthermore, a relative groove curvature Ri of the inner raceway satisfies 0.52≤Ri≤0.58, and/or a relative groove curvature Re of the outer raceway satisfies 0.53≤Re≤0.58. Preferably, the relative groove curvature Ri of the inner raceway satisfies 0.54≤Ri≤0.56, and/or the relative groove curvature Re of the outer raceway satisfies 0.55≤Re≤0.58.

According to this solution, for a bearing with a smaller diameter of rolling elements, by having an inner raceway and/or an outer raceway with a larger relative groove curvature, the friction between the rolling elements and the inner ring and/or the outer ring is reduced, thus significantly reducing the friction torque subjected to by the bearing during rotation, and bringing unexpected improvement to the overall performance of the bearing.

In some solutions, the diameter Dr of the rolling elements satisfies Dr≥0.2*(H1−H2). Preferably, the diameter Dr of the rolling elements satisfies 0.25*(H1−H2)≤Dr≤0.32*(H1−H2).

In some solutions, the inner diameter H2 of the inner ring satisfies 7 mm≤H2≤40 mm. Preferably, the inner diameter H2 of the inner ring satisfies 10 mm≤H2≤30 mm.

In some solutions, the bearing further includes a seal. The seal is arranged at an axial end of the bearing. The seal is fixed to a first one of the outer ring or the inner ring, and a gap is provided between the seal and the other one of the outer ring or the inner ring. Preferably, the seal can be fixed to the outer ring, and the gap is provided between the seal and the inner ring.

According to this solution, by adopting non-contact sealing, the friction between the seal and the outer ring or the inner ring is reduced, thus further reducing the friction torque subjected to by the bearing during rotation.

In some solutions, the gap between the seal and the inner ring has a width extending in the radial direction of the bearing, and the width is between 0.1 mm and 0.2 mm.

According to this solution, if the gap is too large, a good sealing effect cannot be achieved, while if the gap is too small, the seal may hinder the rotation of the bearing, thus increasing the friction torque to which the bearing is subjected during rotation. Therefore, setting the width of the gap in a suitable range is helpful to reduce the friction torque to which the bearing is subjected during rotation, and to basically isolate an inner space of the bearing from the external environment.

In some solutions, the gap between the seal and the inner ring has a length extending in the axial direction of the bearing, and the length is between 0.1 mm and 2 mm.

In some solutions, lubricating oil is provided on the inner raceway and the outer raceway, and the viscosity of the lubricating oil is less than 25 cSt at a temperature of 40° C. Preferably, the viscosity of the lubricating oil is less than 20 cSt at the temperature of 40° C. More preferably, the viscosity of the lubricating oil is less than 15 cSt at the temperature of 40° C.

According to this solution, by using liquid lubricating oil instead of solid lubricating grease as the lubricant, the friction torque to which the bearing is subjected during rotation is further reduced. Moreover, the use of lubricating oil with relatively low viscosity is helpful to reduce the friction between the rolling elements and the inner ring and/or the outer ring, thus reducing the friction torque to which the bearing is subjected during rotation.

In some solutions, the oil film thickness of the lubricating oil one the inner raceway and/or the outer raceway is less than 0.06 mm. Preferably, the oil film thickness is larger than 0.01 mm and less than 0.05 mm.

In some solutions, there is lubricating oil in the free space inside the bearing. The lubricating oil is at least attached to the surface of the inner raceway and the surface of the outer raceway. The volume of the lubricating oil accounts for less than 5% of the volume of the free space inside the bearing. The free space inside the bearing is space of the bearing inner space not occupied by the rolling elements and the cage, and the bearing inner space is space defined by the inner ring, the outer ring and the seal.

According to this solution, by controlling the ratio of the volume of the lubricating oil to the volume of the free space inside the bearing below a certain specific value, the friction torque subjected to by the bearing during rotation is further reduced.

According to a second aspect of the present disclosure, a winding cylinder is provided. The winding cylinder includes a shaft, the bearing according to the first aspect of the present disclosure is provided on the shaft, and a rotatable cylinder is provided on the bearing.

According to a third aspect of the present disclosure, a method for attaching lubricating oil to a bearing is provided, the method is characterized by including: immersing the bearing in the lubricating oil, the bearing including an inner ring with an inner raceway, an outer ring with an outer raceway, rolling elements located between the inner raceway and the outer raceway, a cage for holding the rolling elements, and a seal; performing centrifugal drying operation for the bearing; a diameter Dr of the rolling elements satisfies Dr≤0.35*(H1−H2), H1 being an outer diameter of the outer ring, and H2 being an inner diameter of the inner ring; a relative groove curvature Ri of the inner raceway satisfies 0.52≤Ri≤0.58, and/or a relative groove curvature Re of the outer raceway satisfies 0.53≤Re≤0.58.

In some solutions, the volume of the lubricating oil in a free space inside the bearing that has been provided with the lubricating oil accounts for less than 5% of the volume of the free space inside the bearing. The lubricating oil is at least attached to the surface of the inner raceway and the surface of the outer raceway. The free space inside the bearing is space of the bearing inner space not occupied by the rolling elements and the cage, and the bearing inner space is space defined by the inner ring, the outer ring and the seal.

### BRIEF DESCRIPTION OF THE DRAWINGS

FIG. 1 is a schematic sectional perspective view of a bearing according to an embodiment of the present disclosure.

FIG. 2 is a sectional view through part of a bearing according to an embodiment of the present disclosure.

FIG. 3 is a schematic depiction of relative groove curvature according to an embodiment of the present disclosure.

FIG. 4 is a sectional view of part of a seal according to an embodiment of the present disclosure.

FIG. 5 shows a flowchart of a method for attaching lubricating oil to a bearing according to an embodiment of the present disclosure.

### DETAILED DESCRIPTION

In order to make the purpose, solutions and advantages of the technical scheme of the present disclosure clearer, technical solutions of some embodiments of the present disclosure will be described hereafter clearly and completely with the accompanying drawings of some specific embodiments of the present disclosure. Unless otherwise specified, the terms used herein have the ordinary meaning in the art. In the drawings, the same reference numerals represent the same parts.

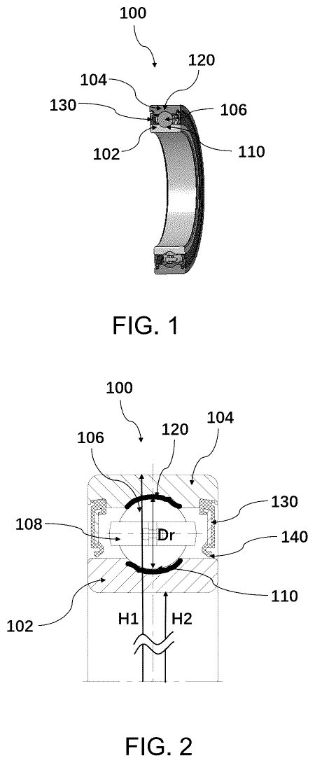

FIGS. 1 and 2 show schematic views of a bearing 100 according to some embodiments of the present disclosure. The bearing 100 includes an inner ring 102, an outer ring 104, rolling elements 106 and a cage 108. The inner ring 102 and the outer ring 104 are configured to rotate concentrically with respect to each other. The inner ring 102 has an inner raceway 110 and the outer ring 104 has an outer raceway 120, and the rolling elements 106 are located between the inner raceway 110 and the outer raceway 120.

In order to reduce the friction torque to which this kind of bearing 100 is subjected during rotation, the inner raceway 110 and/or the outer raceway 120 is provided with a relatively large relative groove curvature. The relative groove curvature can be defined as the raceway radius divided by the diameter of the rolling element 106. The raceway radius is the radius of a circle on which the arc fitting the raceway is located, that is, the radius of curvature of the raceway. That is, the relative groove curvature indicates the curving degree of the inner raceway 110 and/or the outer raceway 120 relative to the rolling element 106, which is equal to the ratio of the radius of curvature of the inner raceway 110 and/or the outer raceway 120 to the diameter of the rolling element 106. According to the definition of the relative groove curvature, if the relative groove curvature is equal to 0.5, it means that the curving degree of the inner raceway 110 and/or the outer raceway 120 is the same as that of the rolling element 106. Obviously, in order to accommodate the rolling element 106 in the inner raceway 110 and/or the outer raceway 120, the relative groove curvature needs to be larger than 0.5.

In some embodiments, the relative groove curvature of the inner raceway 110 is larger than 0.52, and the relative groove curvature of the outer raceway 120 is larger than 0.53.

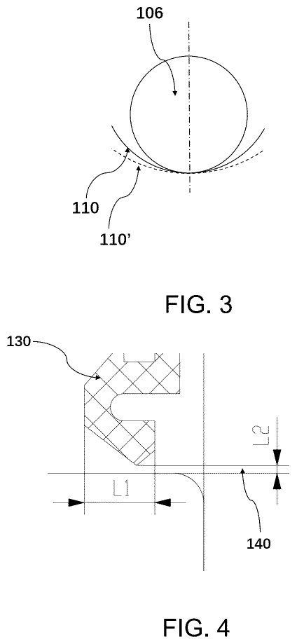

In FIG. 3, the relative groove curvature of the inner raceway 110 is smaller than that of the inner raceway 110′, from which it can be intuitively seen that the larger relative groove curvature of the inner raceway 110 means the larger gap between the rolling element 106 and the inner raceway 110. It should be understood that the relative groove curvature of the outer raceway 120 is similar to that of the inner raceway 110 and will not be described in detail here for the sake of brevity, and FIG. 3 is only schematic and not necessarily drawn to scale. In the bearing 100 of the present disclosure, the relative groove curvature of the inner raceway 110 is larger than 0.52 and/or the relative groove curvature of the outer raceway 120 is larger than 0.53. Properly designing a relatively large relative groove curvature of the inner raceway 110 and/or the outer raceway 120 makes the gap between the rolling element 106 and the inner raceway 110 and/or the outer raceway 120 relatively large, which can reduce the friction between the rolling element 106 and the inner raceway 110 and/or the outer raceway 120, so as to reduce the friction torque subjected to by the bearing 100 during rotation.

For bearings in the existing art, the relative groove curvature of the inner raceway 110 and/or the outer raceway 120 is not designed to be larger than 0.52, or even larger than 0.51. On the other hand, according to the present disclosure, by designing the relative groove curvature of the inner raceway and/or the outer raceway of the bearing significantly larger than that in the existing art, the performance of the bearing 100, especially the friction performance thereof, has been unexpectedly improved, especially for a bearing 100 with rolling elements of a relatively small diameter (for example, the diameter Dr of the rolling element 106 satisfies Dr≤0.35*(H1−H2), where H1 and H2 are the outer diameter and the inner diameter of the outer ring 104 respectively). The friction torque to which the bearing 100 is subjected in this solution during rotation is significantly lower than the friction torque to which a bearing in the existing art is subjected during rotation.

Preferably, the respective relative groove curvatures of the inner raceway 110 and/or the outer raceway 120 may be larger than 0.55. More preferably, the respective relative groove curvatures of the inner raceway 110 and/or the outer raceway 120 may even be larger than 0.57. A larger relative groove curvature of the inner raceway 110 and/or the outer raceway 120 makes the gap between the rolling element 106 and the inner raceway 110 and/or the outer raceway 120 larger, which can further reduce the friction between the rolling element 106 and the inner raceway 110 and/or the outer raceway 120, so as to further reduce the friction torque subjected to by the bearing 100 during rotation.

The present disclosure is particularly suitable for bearings 100 with a smaller diameter of rolling elements 106. Specifically, when the diameter Dr of the rolling elements 106 satisfies Dr≤0.35*(H1−H2), combined with technical features of the present disclosure such as the volume ratio of the lubricating oil in the free space of the bearing, the oil film thickness and the relative curvature of raceways, the friction torque subjected to by the bearing 100 during rotation can be significantly reduced. Preferably, the inner diameter H2 of the inner ring satisfies 7 mm≤H2≤40 mm. More preferably, the inner diameter H2 of the inner ring satisfies 10 mm≤H2≤30 mm.

Preferably, a seal 130 can also be provided at an axial end of the bearing 100. The seal 130 is fixed to one of the outer ring 104 or the inner ring 102, and a gap 140 of elongated shape is provided between the seal 130 and the other of the outer ring 104 or the inner ring 102. In other words, the seal 130 may be fixed to the outer ring 104 with a gap 140 between the seal 130 and the inner ring 102, or the seal 130 may be fixed to the inner ring 102 with a gap 140 between the seal 130 and the outer ring 104. The gap 140 has a width extending in the radial direction of the bearing 100 and a length extending in the axial direction of the bearing 100. During the rotation of the bearing 100, this non-contact sealing of the seal 130 avoids friction torque on the bearing 100 generated by the contact of the seal 130 with the outer surface of the inner ring 102 or the inner surface of the outer ring 104, thus reducing the friction torque subjected to by the bearing 100 during rotation.

Preferably, referring to FIG. 4, the width L2 of the gap 140 between the seal 130 and the inner ring 102 may be between 0.1 mm and 0.2 mm. If the gap 140 is too wide, a good sealing effect cannot be obtained, while if the gap 140 is too narrow, the seal 130 may hinder the rotation of the bearing 100, thereby increasing the friction torque subjected to by the bearing 100 during rotation. Therefore, setting the width of the gap 140 in a suitable range is helpful to reduce the friction torque subjected to by the bearing 100 during rotation, and to basically isolate the inner space of the bearing from the external environment. In addition, the length L1 of the gap 140 between the seal 130 and the inner ring 102 may be between 0.1 mm and 2 mm.

Different from the traditional lubricating method of applying lubricating grease in the bearing 100, according to the present disclosure, lubricating oil is coated in the bearing 100 instead of lubricating grease, especially to the inner raceway 110 and/or the outer raceway 120 where the rolling elements 106 contact the bearing 100, so as to achieve the lubricating effect. Because lubricating oil has a lower viscosity than the lubricating grease, compared with the solution of applying lubricating grease, coating lubricating oil can reduce the friction between the rolling elements 106 and the inner raceway 110 and/or the outer raceway 120, thus reducing the friction torque to which the bearing 100 is subjected during rotation. According to this solution, by adjusting the relative groove curvature, changing the lubricating grease to lubricating oil and controlling the oil quantity, and preferably combining with non-contact sealing, the performance of the bearing, especially the friction performance thereof, has been unexpectedly improved. In some cases, the friction torque to which the bearing 100 is subjected according to this solution during rotation can be reduced by more than 50% compared with the friction torque to which a bearing in the existing art is subjected during rotation. In a preferred case, the friction torque can be reduced to below 1.5 N·mm.

Preferably, the viscosity of the lubricating oil at a temperature 40° C. can be smaller than 25 cSt. The use of lubricating oil with a relatively low viscosity is helpful to further reduce the friction between the rolling elements 106 and the inner ring 102 and/or the outer ring 104, thus reducing the friction torque subjected to by the bearing 100 during rotation. This solution is especially suitable for cases in which external load on the bearing 100 is not large, because the oil film is not easy to be destroyed by the external load due to its low viscosity. Preferably, the viscosity of the lubricating oil at the temperature of 40° C. can be larger than 5 cSt. It should be understood that the present disclosure is not intended to limit the specific value of the viscosity of the lubricating oil, and lubricating oil with any other suitable viscosity can be used.

In the bearing 100 of the present disclosure, the volume of the lubricating oil accounts for less than 5% of the free space inside the bearing, the free space inside the bearing being space of the bearing inner space not occupied by the rolling elements 106 and the cage 108, and the bearing inner space being space defined by the inner ring 102, the outer ring 104 and the seal 130. Using less lubricating oil is helpful to further reduce the friction between the rolling elements 106 and the inner ring 102 and/or the outer ring 104, thus reducing the friction torque subjected to by the bearing 100 during rotation. This solution is especially suitable for cases in which external load on the bearing 100 is not large, because the oil film is not easy to be destroyed by the external load due to its relatively small volume. In addition, the volume of the lubricating oil can also account for less than 3%, preferably less than 2% of the free space inside the bearing, which is helpful to further reduce the friction between the rolling elements 106 and the inner ring 102 and/or the outer ring 104, thus further reducing the friction torque subjected to by the bearing 100 during rotation. In some embodiments, the volume of the lubricating oil accounts for more than 0.5% of the free space inside the bearing.

Accordingly, appropriate volume of the lubricating oil can also be obtained by designing appropriate oil film thickness of the lubricating oil. As shown in FIG. 2, the black thickened portion indicates the oil film, and the thickness formed in the radial direction of the bearing 100 is the oil film thickness. The relationship between the oil film thickness h and the oil film volume V is V=S*h, where S is the surface area where the oil film contacts the outer surface of the inner ring 102 and the inner surface of the outer ring 104. In the solution of the present disclosure, the oil film thickness can be less than 0.05 mm. The use of a thinner oil film is helpful to reduce the friction between the rolling elements 106 and the inner ring 102 and/or the outer ring 104, thereby reducing the friction torque subjected to by the bearing 100 during rotation. The oil film thickness can also be larger than 0.01 mm. If the oil film thickness is too thin, it may lead to insufficient lubrication effect. Therefore, the oil film thickness is set to be larger than 0.01 mm to achieve sufficient lubrication effect. It should be understood that the present disclosure is not intended to limit the specific value of the oil film thickness, and lubricating oil with any other suitable oil film thickness can be used.

The bearing 100 of the present disclosure can be used for a winding machine, which is arranged on a winding shaft supported by the bearing 100 and can be used for winding a lithium battery film. According to the solution of the present disclosure, the friction torque to which the bearing 100 is subjected during rotation is reduced, and uneven thickness or even breakage of the lithium battery film caused by large friction torque is avoided.

The demand for low friction limits the diameter of the rolling elements 106. If the diameter of the rolling elements 106 is too large relative to the overall size of the bearing 100, the rotation of the rolling elements 106 requires more external force, generating higher friction. In addition, if the rolling elements 106 are too large relative to the overall size of the bearing 100, the overall size spacing of the bearing 100 will be compressed, resulting in thinner wall thickness of the inner ring 102 and the outer ring 104, which increases the processing difficulty. On the other hand, if the diameter of the rolling elements 106 is too small relative to the overall size of the bearing 100, it will bring extremely high processing difficulty regarding the cage and the seal 130. Therefore, the diameter Dr of the rolling elements 106 is preferably designed to satisfy Dr≥0.2*(H1−H2). In some embodiments, the diameter Dr of the rolling elements 106 is preferably designed to satisfy 0.25*(H1−H2)≤Dr≤0.32*(H1−H2).

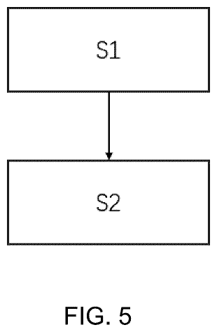

Refer to FIG. 5, which shows a flowchart of a method for attaching (applying) lubricating oil to a bearing according to some embodiments of the present disclosure.

In step S1, the bearing is immersed in the lubricating oil, the bearing including an inner ring with an inner raceway, an outer ring with an outer raceway, rolling elements located between the inner raceway and the outer raceway, a cage for holding the rolling elements, and a seal.

In step S2, centrifugal drying operation is performed for the bearing; a diameter Dr of the rolling elements satisfies Dr≤0.35*(H1−H2), H1 being an outer diameter of the outer ring, and H2 being an inner diameter of the inner ring; a relative groove curvature Ri of the inner raceway satisfies 0.52≤Ri≤0.58, and/or a relative groove curvature Re of the outer raceway satisfies 0.53≤Re≤0.58.

In some embodiments, the relative groove curvature Ri of the inner raceway satisfies 0.54≤Ri≤0.56, and/or the relative groove curvature Re of the outer raceway satisfies 0.55≤Re≤0.58. In some embodiments, the diameter Dr of the rolling elements satisfies Dr≥0.2*(H1−H2). Preferably, the diameter Dr of the rolling elements satisfies 0.25*(H1−H2)≤Dr≤0.32*(H1−H2). In some embodiments, the inner diameter H2 of the inner ring satisfies 7 mm≤H2≤40 mm. Preferably, the inner diameter H2 of the inner ring satisfies 10 mm≤H2≤30 mm.

In some embodiments, a seal provided at an axial end of the bearing, is fixed to one of the outer ring or the inner ring, and wherein a gap is provided between the seal and the other of the outer ring or the inner ring. Preferably, the seal is fixed to the outer ring, and a gap is provided between the seal and the inner ring. In some embodiments, the gap has a width extending in the radial direction of the bearing, and the width L2 is between 0.1 mm and 0.2 mm. In some embodiments, the gap has a length extending in the axial direction of the bearing, and the length L1 is between 0.1 mm and 2 mm.

In some embodiments, the viscosity of the lubricating oil attached to the inner raceway and the outer raceway is less than 25 cSt at a temperature of 40° C. Preferably, the viscosity of the lubricating oil is less than 20 cSt at the temperature of 40° C. More preferably, the viscosity of the lubricating oil is less than 15 cSt at the temperature of 40° C.

In some embodiments, in a free space inside a bearing attached with lubricating oil obtained through the above steps, the volume of the lubricating oil accounts for less than 5% of the volume of the free space inside the bearing. The lubricating oil is at least attached to the surface of the inner raceway and the surface of the outer raceway. The free space inside the bearing is space of the bearing inner space not occupied by the rolling elements and the cage, and the bearing inner space is space defined by the inner ring, the outer ring and the seal. In some embodiments, the volume of the lubricating oil accounts for less than 3% of the free space inside the bearing; preferably less than 2% of the free space inside the bearing. In some embodiments, the volume of the lubricating oil accounts for more than 0.5% of the free space inside the bearing.

In some embodiments, the oil film thickness of the lubricating oil attached to the inner raceway and/or the outer raceway obtained through the above steps is less than 0.06 mm. Preferably, the oil film thickness is larger than 0.01 mm and smaller than 0.05 mm.

A number of exemplary embodiments of the present disclosure have been described in detail herein with reference to some preferred embodiments. However, those skilled in the art can understand that various variations and modifications can be made to the above specific embodiments without departing from the concept of the present disclosure, and various technical features and structures proposed in the present disclosure can be combined without exceeding the protection scope of the present disclosure, which is determined by the appended claims.

What is claimed is:

1. A bearing comprising:
an inner ring having an inner raceway;
an outer ring having an outer raceway;
rolling elements located between the inner raceway and the outer raceway; and
a cage for holding the rolling elements;
wherein a diameter Dr of the rolling elements satisfies Dr≤0.35*(H1−H2), where H1 is an outer diameter of the outer ring, and H2 is an inner diameter of the inner ring; and
a relative groove curvature Ri of the inner raceway satisfies 0.52≤Ri≤0.58, and/or a relative groove curvature Re of the outer raceway satisfies 0.53≤Re≤0.58.

2. The bearing according to claim 1,
wherein the relative groove curvature Ri of the inner raceway satisfies 0.54≤Ri≤0.56, and/or the relative groove curvature Re of the outer raceway satisfies 0.55≤Re≤0.58.

3. The bearing according to claim 1,
wherein a diameter Dr of the rolling elements satisfies Dr≥0.2*(H1−H2).

4. The bearing according to claim 1,
wherein a diameter Dr of the rolling elements satisfies 0.25*(H1−H2)≤Dr≤0.32*(H1−H2).

5. The bearing according to claim 1,
wherein the inner diameter H2 of the inner ring satisfies 7 mm≤H2≤40 mm.

6. The bearing according to claim 1,
wherein the inner diameter H2 of the inner ring satisfies 10 mm≤H2≤30 mm.

7. The bearing according to claim 1, further comprising a seal,
wherein the seal is provided at an axial end of the bearing, and
wherein the seal is fixed to the outer ring or the inner ring and spaced from the inner ring or the outer ring by a gap.

8. The bearing according to claim 1, further comprising a seal,
wherein the seal is provided at an axial end of the bearing, and
wherein the seal is fixed to the outer ring and a gap is provided between the seal and the inner ring.

9. The bearing according to claim 7,
wherein the gap has a width extending in a radial direction of the bearing, and the width is between 0.1 mm and 0.2 mm.

10. The bearing according to claim 9,
wherein the gap has a length extending in an axial direction of the bearing, and the length is between 0.1 mm and 2 mm.

11. The bearing according to claim 1,
including a lubricating oil on the inner raceway and on the outer raceway,
wherein a viscosity of the lubricating oil is less than 25 cSt at a temperature of 40° C.

12. The bearing according to claim 1,
including a lubricating oil on the inner raceway and on the outer raceway,
wherein a viscosity of the lubricating oil is less than 20 cSt at the temperature of 40° C.

13. The bearing according to claim 1,
including a lubricating oil on the inner raceway and on the outer raceway,
wherein a viscosity of the lubricating oil is less than 15 cSt at the temperature of 40° C.

14. The bearing according to claim 11,
wherein an oil film thickness of the lubricating oil on the inner raceway and/or on the outer raceway is between 0.01 mm and 0.05 mm.

15. The bearing according to claim 11,
wherein a volume of the lubricating oil is less than 5% of a volume of a free space inside the bearing.

16. A winding cylinder comprising:
a shaft;
the bearing according to claim 1 arranged on the shaft; and
a rotatable cylinder arranged on the bearing.

17. A method for applying a lubricating oil to a bearing, comprising:
immersing the bearing in the lubricating oil, the bearing including an inner ring with an inner raceway, an outer ring with an outer raceway, rolling elements located between the inner raceway and the outer raceway, a cage for holding the rolling elements, and a seal; and
performing centrifugal drying operation on the bearing;
wherein a diameter Dr of the rolling elements satisfies Dr≤0.35*(H1−H2), where H1 is an outer diameter of the outer ring, and H2 is an inner diameter of the inner ring; and
a relative groove curvature Ri of the inner raceway satisfies 0.52≤Ri≤0.58, and/or a relative groove curvature Re of the outer raceway satisfies 0.53≤Re≤0.58.

18. The method according to claim 17, wherein a volume of the lubricating oil in a free space inside the bearing is less than 5% of a volume of the free space inside the bearing.
